(19) United States
(12) Patent Application Publication
(10) Pub. No.: US 2026/0277217 A1
(43) Pub. Date: Sep. 17, 2026

(54) ADAPTIVE MIXED-MODE MOBILE ROBOT OPERATIONS GUIDED BY SEMANTIC MAPS TO ENHANCE SAFETY AND INTEROPERABILITY IN DYNAMIC INTRALOGISTICS ENVIRONMENTS

(71) Applicant: Innovative Logistics, LLC, Fort Smith, AR (US)

(72) Inventors: Dheenu Kasinathan, Fort Smith, AR (US); Xiongfeng Yi, Fort Smith, AR (US); Aditya Dilip Patil, Fort Smith, AR (US); Solomon Gudeta, Fort Smith, AR (US); Srijith Umakanth, Phoenix, AZ (US); Sanchit Badamikar, Phoenix, AZ (US)

(21) Appl. No.: 19/566,260

(22) Filed: Mar. 13, 2026

Related U.S. Application Data
(60) Provisional application No. 63/771,719, filed on Mar. 14, 2025.

(51) Int. Cl. G05D 1/246; G05D 1/242; G05D 1/622; G05D 101/20

(52) U.S. Cl. CPC G05D 1/2467; G05D 1/2424; G05D 1/622; G05D 2101/20

(57) ABSTRACT

The mobile robot control system (MRCS) allows for the creation of one or more semantic maps comprising semantic annotations defining operational zones within the warehouse (or other intralogistics environment). The operational zones may include automated guided vehicle (AGV) zones and autonomous mobile robot (AMR) zones. The operational zones generally define the operation of the mobile robots while within the boundaries of the operational zone. The semantic map is loaded by each mobile robot at startup and the semantic annotations are utilized to transition the mobile robots between different operational modes based on a current location of the mobile robot on the semantic map. Any changes to the semantic map can be distributed to all mobile robots in real-time or as needed.

### CROSS-REFERENCE TO RELATED APPLICATIONS

This applications claims priority to U.S. Provisional Application Ser. No. 63/771,719, filed Mar. 14, 2025, the entire contents of which are hereby incorporated by reference in their entirety.

### FIELD OF THE INVENTION

The present invention provides a mobile robot control system (MRCS) that enables mobile robots, such as Automated Guided Vehicles (AGVs) or Autonomous Mobile Robots (AMRs), to function in different operational modes by utilizing map semantics integrated into a fleet management system. This MRCS facilitates seamless transitions between operational modes, allowing for the dynamic switching of AGV and AMR functionalities based on the semantic annotations contained within the semantic maps.

### BACKGROUND

In a warehouse environment, safety is of utmost importance, as the interaction between humans, machinery, and goods creates a high-risk setting. The deployment of autonomous forklifts as advanced AGVs significantly enhances operational safety, and fosters trust among human workers. This not only promotes a safer workspace but also minimizes human error and boosts efficiency without compromising safety.

Humans tend to build confidence in autonomous systems when these systems exhibit consistent and predictable behavior. Repeated instances of precise, error-free navigation and task execution are crucial for establishing trust in the mobile robot's capabilities.

Some current systems provide semantic context to the mobile robots through fiducial markers such as machine-readable codes. These fiducial markers are essential to the system's functioning as they encode navigational and operational semantics. If a fiducial marker cannot be read by the mobile robot due to poor lighting, dirt, physical damage, etc., performance of the mobile robots can be degraded or stalled. Further, each time there is a change to the environment, the fiducial markers must be repositioned, or new ones must be added.

Other systems allow mobile robots to transition between different operational modes (e.g., transportation mode and docking mode) based on task requirements. However, these mobile robots are generally utilized in controlled environments with predefined paths and docking procedures, minimizing the need for dynamic obstacle avoidance. These systems do not include the capability to dynamically transition between different operational modes because they operate in a structured environment, often with little to no worker presence. Therefore, a need exists for an MRCS in which each mobile robot in a warehouse environment can seamlessly and dynamically transition between two or more operational modes.

### SUMMARY

The MRCS allows for the creation of one or more semantic maps comprising semantic annotations defining operational zones within the warehouse (or other intralogistics environment). The operational zones may include automated guided vehicle (AGV) zones and autonomous mobile robot (AMR) zones. The operational zones generally define the operation of the mobile robots while within the boundaries of the operational zone. The semantic map is loaded by each mobile robot at startup and the semantic annotations are utilized to transition the mobile robots between different operational modes based on a current location of the mobile robot on the semantic map. Any changes to the semantic map can be distributed to all mobile robots in real-time or as needed.

### BRIEF DESCRIPTION OF THE DRAWINGS

FIG. 1 depicts a system diagram of the MRCS according to an embodiment of the invention.

FIG. 2 depicts an example semantic map according to an embodiment of the invention.

FIGS. 3A and 3B depict the path of a mobile robot in an AGV zone versus an AMR zone, respectively, according to an embodiment of the invention.

FIG. 4 depicts a flowchart showing the steps utilized for the creation and distribution of semantic maps according to an embodiment of the invention.

FIG. 5 depicts a flowchart showing the steps utilized by a mobile robot to transition between operational modes according to an embodiment of the invention.

FIG. 6 depicts a representation of the layers within a semantic map according to an embodiment of the invention.

FIG. 7 depicts an example coordinate map for zones within a semantic layer according to an embodiment of the invention.

FIGS. 8A and 8B depict information and rules that may be associated with each operational zone in a semantic map according to an embodiment of the invention.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

The embodiments disclosed herein are for the purpose of providing a description of the present subject matter, and it is understood that the subject matter may be embodied in various other forms and combinations not shown in detail. Therefore, specific embodiments and features disclosed herein are not to be interpreted as limiting the subject matter as defined in the accompanying claims.

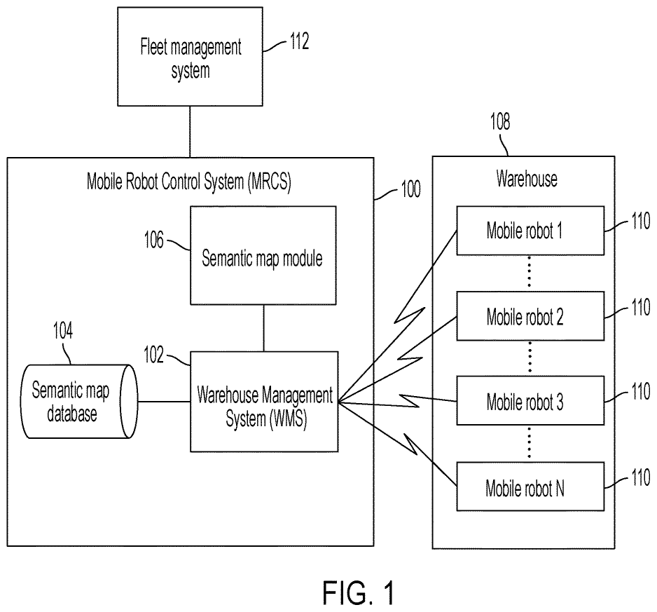

Referring first to FIG. 1, depicted are the principal components of the MRCS 100. MRCS 100 allows for the creation of semantic maps 200 to improve the efficiency and adaptability of robotic systems in warehouse settings. This is achieved by implementing a dynamic mode-switching capability in each mobile robot 110 that allows for seamless transitions between two or more operational modes including, but not limited to, Automated Guided Vehicle (AGV) mode and Autonomous Mobile Robot (AMR) mode, utilizing semantic information on the semantic map 200.

As used herein, mobile robot 110 may be any autonomous or semi-autonomous vehicle capable of locomotion (e.g., using wheels) within robot environment 108 capable of receiving a route from WMS 102 and executing the route. Mobile robot 110 may comprise one or more processors, memory, storage, environmental sensors, etc. as is known in the art for receiving navigation instructions (e.g., from WMS 102 and navigating through the robot environment.

In AGV mode, the mobile robot 110 operates by adhering to a predetermined path that is established through fleet management system 112. The fleet management system 112 defines the routes that each mobile robot 110 follows, ensuring movements are systematic and efficient. One of the key features of AGV mode is the ability of mobile robot 110 to detect obstacles in its path. When an obstacle is detected within a safe distance (e.g., 5 meters), the mobile robot 110 automatically halts its movement until the obstacle is handled or cleared (e.g., by a supervisor or worker). This safety feature is essential as it not only protects the mobile robot 110 from potential collisions but also ensures the safety of human workers in the vicinity. By stopping in response to obstacles, the mobile robot 110 contributes to a collaborative work environment where human operators can work alongside it without fear of unexpected movements.

The predictable movement of the robot is a significant advantage in industrial settings such as warehouse 108. Human workers can easily anticipate the actions and behavior of mobile robot 110, which fosters a sense of security and enhances overall productivity. This predictability allows for smoother interactions between humans and mobile robots 110, as workers can plan their tasks around the movements of mobile robots 110, leading to a more efficient workflow.

In summary, the AGV mode enhances operational safety and efficiency by utilizing advanced fleet management system 112 to guide the mobile robots 110 along a defined path while incorporating obstacle detection mechanisms that ensure a secure working environment for human operators.

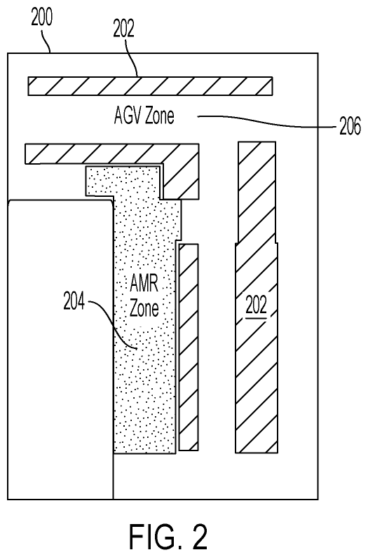

Current solutions face considerable challenges in high-traffic, dynamic environments, particularly in warehouses 108 where frequent stops for obstacles can significantly impede operational efficiency. To address this pressing issue, MRCS 100 incorporates the concept of operational zones on the semantic map 200, such as AGV zones 206 and AMR zones 204 depicted in FIG. 2. Boundaries 202 depict known obstacles within warehouse 108 such as storage racks, walls, etc. where mobile robots 110 cannot navigate. AMR zones 204 are designated areas within the warehouse 108 that are identified as high-dynamic zones through advanced semantic mapping integrated into the fleet management system 112.

The default operations zones (e.g., AGV zone 206 or AMR zones 204) can be set in the MRCS 100. If only two types of operational zones are defined in the sematic map 200, a first type of operational mode (e. g,, AGV mode) may be set as the default operational mode and a second type of operational mode can be indicated using the semantic information such as AMR zones 204. Mobile robots 110 can be programmed to operate in AGV mode except when it is determined that they are located in an AMR zones 204. Further, only the boundaries of AMR zones 204 need to be modified or updated as the mobile robot 110 operates in the default mode (e.g., AGV mode) when not in AMR zones 204. Likewise, if the default mode is set to AMR mode, the mobile robot 110 will be operated as AMR everywhere except inside AGV zone 206 defined in semantics map 200.

In these AMR zones 204, the mobile robot 110 transitions seamlessly into AMR mode from AGV mode (or other operational mode), which enhances its ability to navigate around obstacles effectively. AMR mode allows the mobile robot 110 to maintain continuous operation without the need for frequent halts, thereby optimizing workflow and productivity. The implementation of AMR zones 204 not only facilitates efficient obstacle avoidance but also ensures that safety protocols are rigorously upheld.

By leveraging real-time data and sophisticated mapping techniques, the fleet management system 112 can dynamically adjust the robot's path in response to changing conditions within the warehouse 108. This adaptability is crucial in environments where the layout may frequently change due to the movement of goods or personnel such as warehouse 108. Furthermore, the establishment of AMR zones 204 (or other operational zones) can lead to a more organized warehouse layout, as these operational zones can be strategically placed to minimize congestion and enhance the overall flow of operations.

In summary, the introduction of AMR zones 204 represents a significant advancement in warehouse automation, enabling mobile robots 110 to operate more efficiently and safely in complex, high-traffic environments. This not only improves operational efficiency, but also contributes to a safer working environment for all personnel involved. This innovative hybrid approach, which allows for seamless transitions between Automated Guided Vehicle (AGV) and Autonomous Mobile Robot (AMR) modes based on semantic information, marks a significant advancement in warehouse automation.

Generally, MRCS 100 comprises warehouse management system (WMS) 102, semantic map module 106, and semantic map database 104. WMS 102 may perform a plurality of other functions besides the functions described herein such as surveillance, statistics, etc., but only the functions relevant to the present invention are described herein. In a preferred embodiment, semantic map module 106 provides a user interface allowing personnel to create and annotate semantic map(s) 200 with semantic data including different operational zones such as obstacles 202, AGV zones 206, AMR zones 204, or any other number of operational zones (e.g., pick-up zones, drop-off zones, off-limit zones, charging zones, etc.). The created semantic maps 200 are stored in semantic map database 104 for distribution to mobile robots 110 as will be described later.

Each semantic map 200 may also include one or more layers to provide semantic information specific to different types or classifications of mobile robots 110. For example, a first mobile robot 110 may be an autonomous forklift whereas a second mobile robot 110 may be a surveillance robot. The AMR zones 204 designated for an autonomous forklift may be different than those for a surveillance robot and stored in different layers on semantic map 200, with each layer corresponding to a different robot type. The different layers may also be stored as separate semantic maps 200 in semantic map database 104, with each semantic map 200 being associated with a particular mobile robot 110 or classification of mobile robot 110. The semantic information for each semantic map 200 may also comprise layers for time of day (e.g., different layers for daytime operation vs. overnight operation) or any other factors.

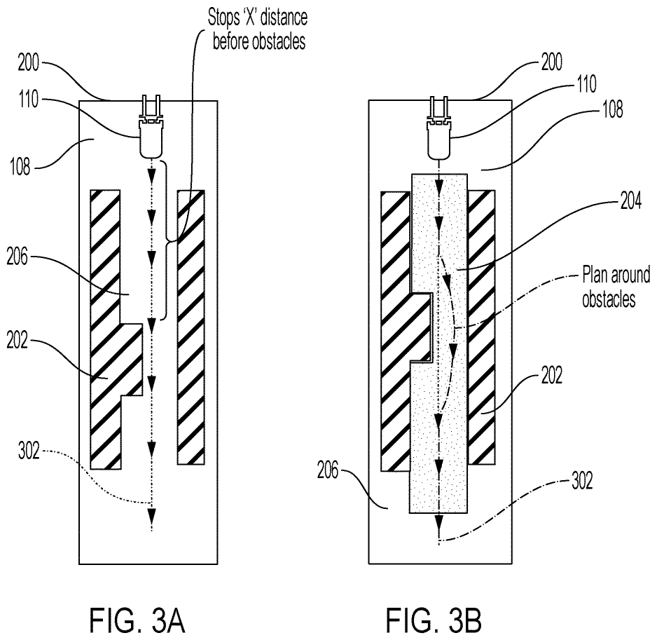

FIG. 3A depicts the route 302 of a mobile robot 110 operating in AGV mode in AGV zone 206 in warehouse 108. As shown, mobile robot 110 follows a generally straight route 302 through AGV zone 206 and stops a predetermined distance before any detected obstacle. In contrast, FIG. 3B depicts the route 302 of mobile robot 110 through AMR zone 204 in warehouse 108. Because the mobile robot 110 operates in AMR mode in AMR zone 204, the route 302 deviates around any detected obstacles or instructions instead of stopping.

The operational zones are defined based upon the position of the mobile robot 110 on semantic map 200 and do not depend on fiducial markers such as barcodes. Instead, mobile robot 110 derives semantic information directly from the environment, semantic map 200, or contextual cues within the intralogistics facility. This provides a unique capability for each mobile robot 110 to switch between AGV modes and AMR modes based on semantic map interpretations, allowing greater operational flexibility in logistics environments. Further, because semantic maps 200 can be updated centrally using semantic map module 106, each mobile robot 110 is provided updated semantic information and automatically adapts to layout changes using the updated semantic maps 200 and sensors. The mobile robot 110 automatically switches between AGV (fixed-path navigation) mode and AMR (active real-time obstacle avoidance) mode dynamically, guided by semantic map 200, enabling it to adapt to varying environmental conditions. This approach is applicable across various industries requiring flexible navigation strategies, adapting to both structured and dynamic environments.

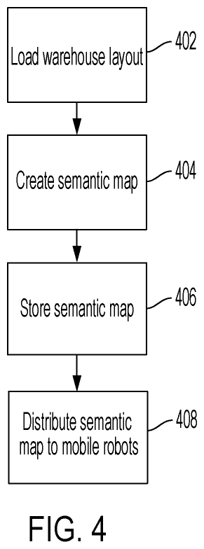

Referring next to FIG. 4, depicted is a flowchart showing the steps utilized to create and distribute a semantic map 200 according to an embodiment of the invention. First, a map of the warehouse is loaded into semantic map module 106 in step 402. The map may be created manually by the user as is known in the art or from data gathered by one or more mobile robots 110 (e.g., aggregated LIDAR data from mobile robots 110). Next, the user annotates the warehouse map with semantic data, such as obstacles 202, AMR zone 204, AGV zones 206, etc., to create semantic map 200 (e.g., FIG. 2) in step 404. Once created, the semantic map 200 is stored in semantic map database 104 in step 406. Steps 402-406 may be repeated as necessary to update semantic map 200 or create additional semantic maps 200 as needed. The semantic map 200 is distributed to each mobile robot 110 in step 408 at startup or each time the semantic map 200 is updated. This ensures that each mobile robot 110 is always provided with the most recent version of semantic map 200. This workflow integrates advanced warehouse management with autonomous robot operations to ensure efficient and safe navigation of mobile robots 110 within warehouse 108.

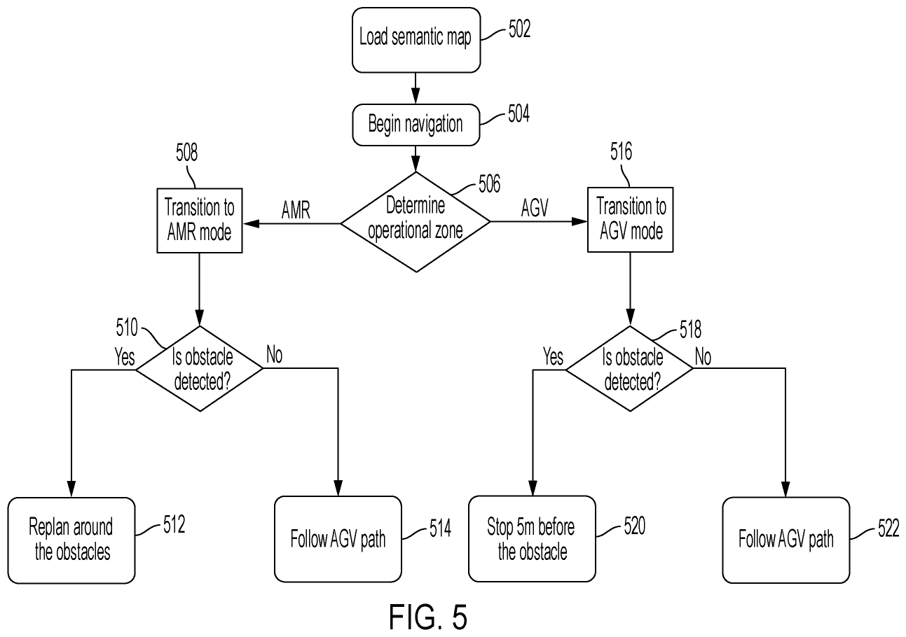

FIG. 5 depicts a flowchart showing the steps utilized by each mobile robot 110 for navigating using semantic maps 200. At startup of mobile robot 110, semantic map 200 is loaded into a memory of mobile robot 110 in step 502. Mobile robot 110 then begins navigation of warehouse 108 under direction of fleet management system 112 or in accordance with predefined tasks in step 504. The mobile robot 110 constantly monitors its location within warehouse 108 and determines if it is in an operational zone by referencing semantic map 200 in step 506.

If mobile robot 110 determines that it is in an AMR zone 204 in step 506, the mobile robot 110 dynamically transitions to AMR mode in step 508. If an obstacle is detected by mobile robot in step 510, mobile robot 110 (or fleet management system 112) replans a route 302 around obstacles without stopping movement of mobile robot 110 in step 512. If no obstacle is detected in step 510, the predetermined route 302 is followed in step 514 (e.g., same as AGV path).

If mobile robot 110 determines that it is in an AGV zone in step 506, the mobile robot 110 dynamically transitions to AGV mode in step 516. If an obstacle is detected by mobile robot 110 in step 518, mobile robot 110 (or fleet management system 112) stops mobile robot 110 a predetermined distance before the detected obstacle in step 520 and remains stopped until the obstacle moves (e.g., a worked moves away) or is relocated. If no obstacle is detected in step 518, the predetermined route 302 is followed in step 522.

In AGV zones 206, the mobile robot 110 follows predefined routes 302 or paths marked within the semantic map 200, ensuring predictable and safe movement. This behavior is ideal for areas with high-density traffic or narrow aisles. In AMR zones 204, the mobile robot 110 operates with greater autonomy, using advanced obstacle detection and avoidance algorithms to navigate safely without fixed routes or stopping.

MRCS 100 enables real-time transitions between AGV mode and AMR mode (or any other number of operational modes). This adaptability is guided by semantic map annotations that define operational zones, allowing the mobile robot 110 to adjust its navigation strategy dynamically in response to environmental changes. By leveraging semantic maps 200, MRCS 100 facilitates seamless interoperability with various operational environments and existing infrastructure. The ability to switch modes based on zone semantics enhances safety, as the mobile robot 110 can employ obstacle avoidance in dynamic areas (AMR mode) and follow fixed paths in stable zones (AGV mode), thereby optimizing performance and reducing collision risks.

MRCS 100 enables scalability, allowing for integration into diverse intralogistics settings without extensive reconfiguration. The semantic mapping approach provides flexibility, enabling the mobile robot 110 to adapt to new zones and operational requirements efficiently, which is a significant advancement over systems with rigid, task-specific modes.

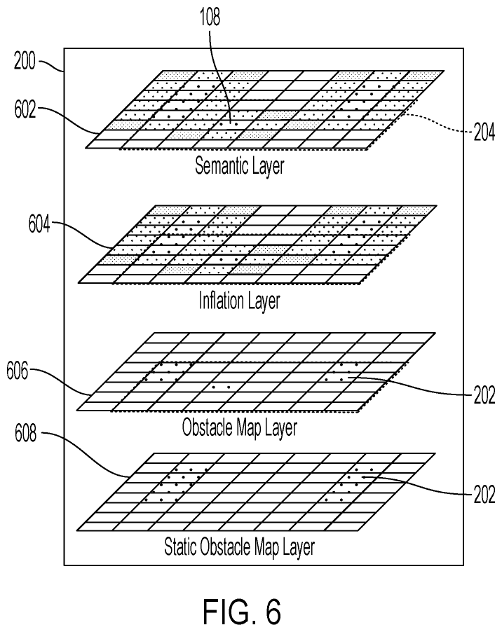

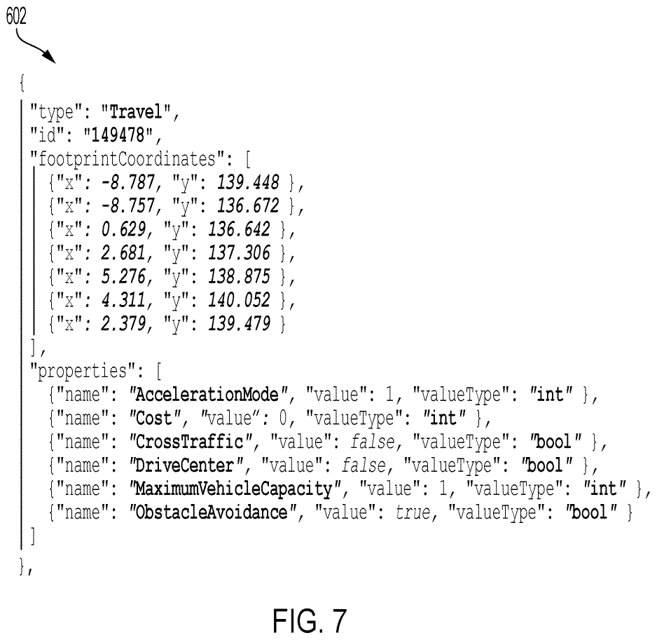

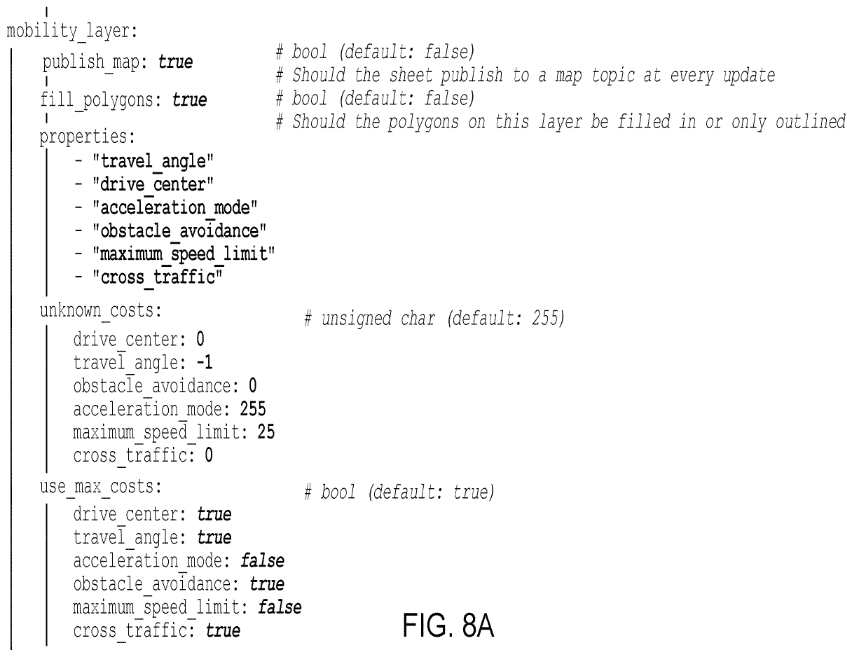

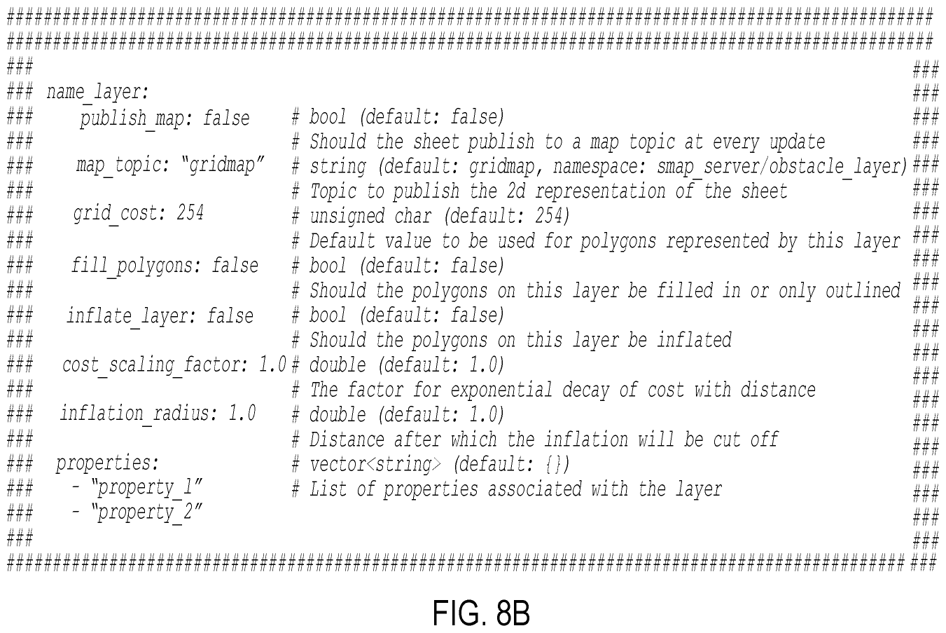

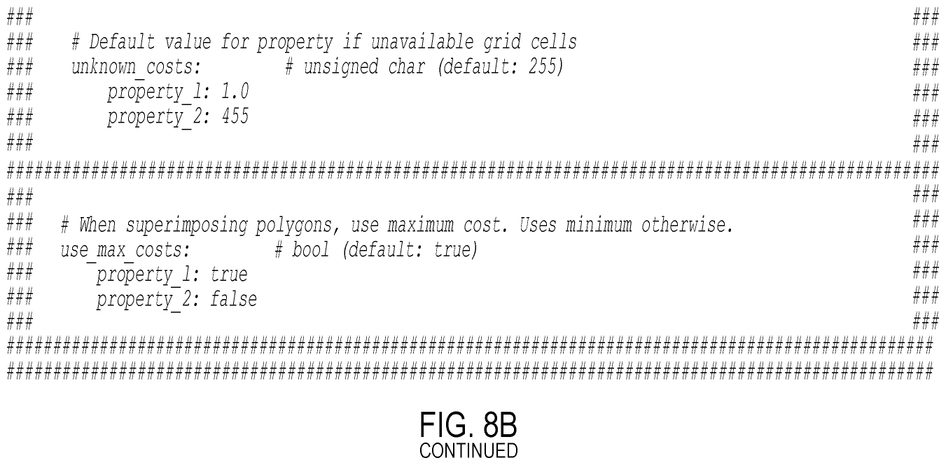

As depicted in FIG. 6 each semantic map 200 may comprise two or more layers according to an embodiment of the invention. Each layer may utilize a global coordinate system associated with a particular layout, such as warehouse 108. For example, the warehouse layout may be divided into a grid representing areas of the warehouse. The resolution of the grid (e.g., x-length by y-length) may depend on the granularity of information that needs to be represented on each layer. For example, semantic map 200 may include semantic layer 602, inflation layer 604, obstacle map layer 606, and static obstacle map layer 608. Static obstacle map layer 608 includes locations and information about fixed objects in the environment such as walls, racks, etc. and generally only requires updating if the layout of warehouse 108 is changed. Obstacle map layer 606 includes location and information about objects to be avoided in the warehouse 108 (e.g., locations of workers or freight). Inflation layer 604 defines a buffer zone around any desired objects or fixed barriers in the warehouse 108 that may be needed. Finally, semantic layer 602 may also define locations of points of interest (POIs) within warehouse 108 such as pick-up locations, drop-off locations, etc. as well as boundaries of different operational zones for semantic map 200 such as AGV zone 206, AMR zone 204, acceleration zones, cross-traffic zones, drive center zones, maximum vehicle capacity zones, obstacle avoidance zones, etc. An example coordinate map for zones within semantic layer 602 is depicted in FIG. 7. FIGS. 8A and 8B depict information and rules that may be associated with each operational zone in semantic map 200.

While the present invention has been described with respect to what is presently considered to be the preferred embodiments, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

1. A mobile robot control system (MRCS) comprising:
a first mobile robot (MR);
a semantic module for creating and storing a plurality of semantic maps,
wherein each semantic map comprises a plurality of layers; and
a warehouse management system (WMS) to determine a route for the first MR within a logistics environment,
wherein the WMS transmits the route to the first MR and a first semantic map from the plurality of semantic maps, and
wherein the first MR executes the route autonomously, and
wherein the first MR utilizes semantic information in a semantic layer of the first semantic map to select an operational mode from a plurality of operational modes depending upon a current position of the first MR in the logistics environment.

2. The MRCS of claim 1, wherein the first semantic map is unique to the first MR.

3. The MRCS of claim 1, wherein the first semantic map is unique to a vehicle type of the first MR.

4. The MRCS of claim 1, wherein the semantic information in the semantic layer comprises:
a plurality of zones defined in the logistics environment,
wherein each zone of the plurality of zones is assigned a zone type from a plurality of zone types.

5. The MRCS of claim 4, wherein the plurality of zone types comprise:
an automated guided vehicle (AGV) zone; and
an autonomous mobile robot (AMR) zone.

6. The MRCS of claim 5, wherein the first MR operates in the AMR mode when in an AMR zone, and
wherein the first MR operates in the AGV mode when in an AGV zone.

7. The MRCS of claim 6, wherein the first MR stops a predetermined distance before a detected obstacle when in the AMR mode, and
wherein the first MR does not move until the detected obstacle is moved or a new route is received from the WMS.

8. The MRCS of claim 7, wherein the first MR navigates around a detected obstacle when in the AGV mode before resuming the route.

9. The MRCS of claim 1, further comprising:
a second MR;
wherein the WMS transmits a second route to the second MR and a second semantic map from the plurality of semantic maps,
wherein the second semantic map is different than the first semantic map.

10. The MRCS of claim 1, wherein the plurality of layers comprise:
the semantic layer;
an inflation layer
an obstacle layer; and
a static obstacle layer.

11. The MRCS of claim 10 wherein the static obstacle layer and the obstacle layer are the same for each semantic map of the plurality of semantic maps.

12. The MRCS of claim 10, wherein the inflation layer defines a buffer zone around specific obstacles in the obstacle layer and static obstacles in the obstacle layer.

13. The MRCS of claim 10, wherein the obstacle layer is updated in real-time by the WCS.

14. The MRCS of claim 10, wherein the first semantic map is retransmitted to the first MR when the obstacle layer is updated.

15. The MRCS of claim 1, wherein the first semantic map comprises a plurality of semantic layers, and
wherein each semantic layer of the plurality of semantic layers is associated with a specific time of day and/or a specific day.

16. The MRCS of claim 1, wherein the semantic information in the semantic layer comprises:
a plurality of zones defined in the logistics environment,
wherein the first MR operates in a default mode when not located in any zone of the plurality of zones.
